(19) United States
(12) Patent Application Publication
(10) Pub. No.: US 2022/0012765 A1
(43) Pub. Date: Jan. 13, 2022

(54) PROCESSING REMOTE INTERACTIONS USING CONTEXT-SPECIFIC IDENTIFIERS

(71) Applicant: Visa International Service Association, San Francisco, CA (US)

(72) Inventors: Manoj Kannembath, Foster City, CA (US); Aaron Stark, San Francisco, CA (US); Jalpesh Chitalia, Castro Valley, CA (US)

(21) Appl. No.: 17/370,848

(22) Filed: Jul. 8, 2021

Related U.S. Application Data
(60) Provisional application No. 63/051,209, filed on Jul. 13, 2020.

(51) Int. Cl. G06Q 30/02; G06Q 20/32

(52) U.S. Cl. CPC G06Q 30/0233; G06Q 20/3276; G06Q 30/0236; G06Q 30/0234

(57) ABSTRACT

During a transaction, a user may wish to determine if there are benefits available to the user, which may be applicable to the transaction with a resource provider. An application on the user device receives and transmits a resource provider identifier of the resource provider to a server computer. The server computer may identify a remote processor associated with the resource provider, and communicate with the remote processor to identify one or more benefits applicable to the transaction. The server computer may send the applicable benefit(s) to the application on the user device. The user may select one or more of the applicable benefits, and transmit the selection to the server computer, which may initiate processing of the transaction in view of the selected benefits.

### CROSS-REFERENCE TO RELATED APPLICATIONS

This application claims benefit under 35 USC§ 119(e) to U.S. Provisional Patent Application No. 63/051,209 filed Jul. 13, 2020 and entitled “Solution For Loyalty In Merchant Presented Acceptance Use Cases”, the disclosure of which is incorporated by reference herein in its entirety for all purposes.

### BACKGROUND

Current transaction systems are moving towards supporting merchant-presented acceptance use cases. In such cases, a merchant may present a QR code to a consumer at a time of purchase. The consumer may then scan the QR code with a mobile device in order to initiate an authorization process for the purchase. Currently, merchant-presented acceptance use cases only address a method of conducting payment transactions using a standard transaction system. However, these merchant-presented acceptance use cases do not yet solve for application of user-selected benefits, such as loyalty points, membership privileges, or any other type of discounts, at time of payment.

Embodiments are directed to addressing these and other problems, individually and collectively.

### SUMMARY

Embodiments allow for identifying and applying benefits to a transaction where the resource providing entity is offline with respect to the transaction processing entities. More specifically, embodiments allow for an application on a user device to communicate with a server computer to identify, and then select one or more benefits applicable to a transaction between the user and a resource provider. The server computer may receive the resource provider identifier and identify a remote processor associated with the resource provider for determining benefits applicable to the transaction. The benefits are then presented to the user, who selects one or more of the benefits, and the transaction is processes based on the selected benefits.

One embodiment is directed to a method comprising: receiving, by a server computer, a benefit verification request message comprising benefit data and entity identifying information for an entity from a mobile application on a mobile device. The benefit verification request message is generated by the mobile application in response to the mobile application receiving the entity identifying information in connection with a transaction with the entity. The method further comprises determining, by the server computer, a remote processor associated with the entity using the entity identifying information; transmitting, by the server computer, a verification request message to the determined remote processor for verifying the benefit data in view of the transaction; and receiving, by the server computer, a verification response message from the remote processor. The method also includes transmitting, by the server computer, a benefit verification response message to the mobile application on the mobile device. The benefit verification response message includes one or more benefits applicable to the transaction. The server computer then receives, from the mobile application, a transaction processing request message for the transaction. The transaction processing request message comprises the entity identifying information and a transaction amount based on the benefit verification response message. The server computer transmits the transaction processing request message to the remote processor. The remote processor initiates an authorization process of the transaction based on information included in the transaction processing request message.

Another embodiment is directed to a server computer comprising: a processor; and a computer readable medium, the computer readable medium comprising code, executable by the processor for implementing the above method.

Further details regarding embodiments of can be found in the Detailed Description and the Figures.

### BRIEF DESCRIPTION OF THE DRAWINGS

FIG. 1 shows a system and method for conducting a transaction which includes the use of benefit(s) applicable to the transaction, according to various embodiments;

FIG. 2 shows a flowchart diagram for retrieving and applying benefits to a transaction, according to various embodiments;

FIGS. 3A-3D show a series of exemplary screen views of a mobile device for receiving and selecting benefits applicable to a transaction according to various embodiments;

FIG. 4 shows a block diagram of an exemplary mobile device according to various embodiments; and

FIG. 5 shows a block diagram of an exemplary server computer according to various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Prior to discussing embodiments, some terms can be described in further detail.

A “user” may include an individual or a computational device. In some embodiments, a user may be associated with one or more personal accounts and/or user devices (e.g. mobile devices). In some embodiments, the user may be a cardholder, account holder, or consumer.

A “mobile device” (sometimes referred to as a mobile communication device) may comprise any suitable electronic device that may be transported and operated by a user, which may also provide remote communication capabilities to a network. A mobile communication device may communicate using a mobile phone (wireless) network, wireless data network (e.g. 3G, 4G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g. cellular phones), PDAs, tablet computers, net books, laptop computers, wearable devices (e.g., watches, bracelets, rings, contact lenses, glasses), vehicles such as automobiles and motorcycles, personal music players, hand-held specialized readers, etc. A mobile device may comprise any suitable hardware and software for performing such functions, and may also include multiple devices or components (e.g. when a device has remote access to a network by tethering to another device—i.e. using the other device as a modem—both devices taken together may be considered a single mobile device).

A “resource provider” or a “resource providing entity” can be any suitable entity that provides resources (e.g., goods, services, access to secure data, access to locations, or the like) during a transaction. For example, a resource providing entity can be a merchant, a venue operator, a building owner, a governmental entity, etc. A “merchant” may typically be an entity that engages in transactions and can sell goods or services, or provide access to goods or services.

An “application” may refer to any set of computer-executable instructions configured to cause a processor to execute a function or access a resource. An application may be installed on, and executed from, a user device. Applications may be installed on a user device by a manufacturer of the user device or by another entity. An application installed on a mobile user device may be referred to as a mobile application.

An “access device” may be any suitable device for providing access to an external computer system. An access device may be in any suitable form. Some examples of access devices include point of sale (POS) devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a mobile device.

“Payment credentials” may include any suitable information associated with an account (e.g. a payment account and/or payment device associated with the account). Such information may be directly related to the account or may be derived from information related to the account. Examples of account information may include a PAN (primary account number or “account number”), user name, expiration date, and verification values such as CVV, dCVV, CVV2, dCVV2, and CVC3 values.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “issuer” may be a business entity which issues a payment account that can be used to conduct transactions. Typically, an issuer is a financial institution.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

A “server computer” is typically a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “machine-readable code” may include any images or symbols that can be read through an electronic device for interpretation and manipulation by a computer. Some examples of machine-readable codes include barcodes, quick response (QR) codes, Military Spec UID codes, and any other suitable code.

A “transaction” may be any interaction or exchange between two or more parties. For example, a transaction may include a first entity requesting resources from a second entity. In this example, the transaction is completed when the resources are either provided to the first entity or the transaction is declined.

Details of some embodiments will now be described in greater detail.

Embodiments are directed to determining if a benefit (e.g. a benefit account identifier, a discount, membership points, promotions, etc.) can be applied during a transaction between a user and a resource provider. In some embodiments, the transaction may be initiated by the resource provider presenting a machine-readable code (e.g. a QR code) to an application (e.g. mobile application) installed on user device of the user. The machine-readable code may include a resource provider identifier that uniquely identifies the resource provider. The machine-readable code may include other information, such as transaction-related information (e.g. transaction amount, items or service being provided, etc.). In other embodiments, the resource provider identifier may be provided to the application in any other suitable manner, such as by being manually entered by the user, via a text message or an email received at the user device, among other ways. The user may wish to determine if there are benefits available to the user, which may be applicable to the current transaction. The application may transmit the resource provider identifier to a server computer. The server computer may identify a remote processor associated with the resource provider, and communicate with the remote processor to identify one or more benefits applicable to the transaction. The server computer may send the applicable benefit(s) to the application on the user device. The user may select one or more of the applicable benefits, and transmit the selection to the server computer, which may initiate processing of the transaction in view of the selected benefits.

According to various embodiments, the applicable benefit may include participation in a loyalty program, application of a discount, earning or applying a membership point, receipt of a promotional item, among other benefits. For example, applying a benefit to a transaction may include using one or more loyalty discounts associated with a benefit account identifier. In some embodiments, applying the benefit to the transaction may further include using loyalty points associated with the benefit account identifier in exchange for a loyalty discount. In some embodiments, the request for benefit verification may be sent to the server computer prior to initiating the transaction or independently from the transaction. For example, the user may request the benefit verification prior to interacting with the resource provider, as long as the user may provide the resource provider identifier to the application on the user device.

In embodiments, the server computer is used as an intermediary between the user device (e.g. a mobile device) operated by a user and the remote processor (e.g. a virtual terminal, a remote processing server, a resource provider server on the cloud, a payment processor or facilitator) associated with the resource provider conducting the transaction. According to various embodiments, the resource provider may not be in direct communication with the remote processor. That is, the resource provider may be offline with respect to the remote processor. The resource provider may also be offline with respect to the server computer. For example, the resource provider may be located at an area without a network connection (e.g. without an internet connection). The server computer may receive, from the application on the user device, a resource provider identifier incorporated in a benefit verification request message. The benefit verification request message may further include a benefit account identifier associated with the user of the user device. The server computer may identify the remote processor associated with the resource provider based on the resource provider identifier received in the benefit verification request message. The server computer may then transmit the received resource provider identifier and (if applicable) the benefit account identifier to the remote processor associated with the resource provider. The remote processor determines if the benefit account identifier is associated with any benefits that may be applied to the transaction. The server computer receives a result of the determination (e.g. the identified benefits that are applicable to the transaction) and communicates the determination to the mobile application on the user device. The user of the user device may select one or more of the applicable benefits, and the application may determine a transaction amount for the transaction based on the selected benefit(s). A transaction processing request is then routed to the remote processor via the server computer.

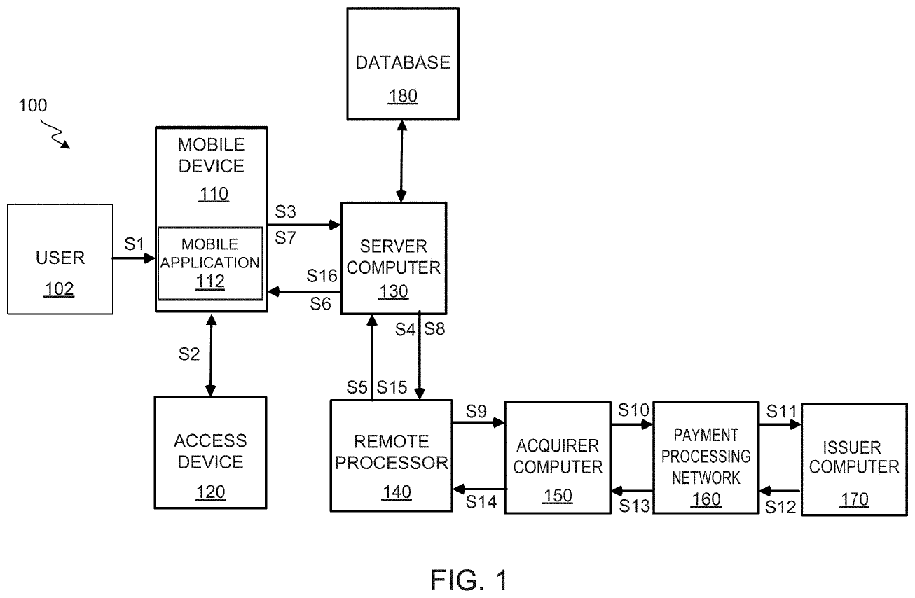

FIG. 1 shows an exemplary system 100 according to various embodiments. The system 100 includes a mobile device 110 (operated by a user 102), an access device 120 associated with a resource provider (e.g. a merchant), a server computer 130, and a remote processor 140 (e.g. a virtual terminal, a resource provider processor) associated with the resource provider. The system 100 further comprises an acquirer computer 150, a payment processing network 160, and an issuer computer 170 for processing an authorization of a transaction. According to various embodiments, the server computer 130 and the payment processing network 160 may be owned, operated and/or managed by a same entity, or may be part of a same network.

The components shown in FIG. 1 may be in operative communication with each other. According to various embodiments, the access device 120 and the remote processor 140, while associated with the same resource provider, may not be in communication with each other. For example, the access device 120 may be offline with respect to the remote processor 140, and/or the server computer 130.

The components in the system 100 that are in operative communication with each other may do so through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

FIG. 1 further illustrates a set of steps performed by various entities represented in the system 100.

In step S1, the user 102 accesses a mobile application 112 (e.g. a mobile payment application, a merchant application) stored on the mobile device 110. For example, the user 102 may provide a resource provider identifier to the mobile application 112 by entering the resource provider identifier using the keys or virtual keys of the mobile device 110.

In some embodiments, the resource provider identifier may be provided to the mobile application 112 by scanning a machine-readable code (e.g. QR code) in step S2. The machine-readable code may be generated by, and presented on the access device 120 associated with the resource provider. For example, the machine-readable code may be generated as part of a transaction, and may further include transaction-related information such as a transaction amount. In some embodiments the access device 120 may be a mobile device or a point of sale (POS) terminal operated by the resource provider. In step S2, the user 102 may initiate a transaction with the resource provider. The mobile application 112 on the mobile device 110 may receive the resource provider identifier using a Bluetooth network and/or near-field communication. In some embodiments, the resource provider identifier may be dynamic, such that the dynamic resource provider identifier may be updated at a later point during the transaction to include additional transaction details.

The machine-readable code may include the resource provider identifier, an acquirer identifier, and/or a terminal identifier. In some embodiments, the machine-readable code may include a static QR code, such that the QR code includes all necessary transaction information. For example, a static QR code may comprise a complete list of goods and/or services that the user 102 wishes to purchase from the resource provider. In other embodiments, the machine-readable code may include a dynamic QR code, such that the QR code may be updated at a later time during the transaction. For example, a dynamic QR code may be scanned before a user 102 adds all desired goods and/or services to a checkout service. In such embodiments, the dynamic QR code may be updated to include an updated transaction amount or a complete list of all desired goods and/or services at a later point in the transaction.

In some embodiments, responsive to receiving the resource provider identifier, the mobile application 112 may prompt user 102 with one or more options to apply a loyalty account to the transaction. The user 102 may provide the a benefit account identifier associated with the loyalty account to the mobile application 112. In some embodiments, the benefit account identifier associated with the user may already be stored in the mobile application 112.

In step S3, if the user 102 selects an option for applying the loyalty account to the transaction, the mobile application 112 may transmit a benefit verification request message to server computer 130. The benefit verification request message may include the resource provider identifier, and in some embodiments, the benefit account identifier associated with the loyalty account of the user. The benefit verification request message aims to identify the types of benefits (e.g. discount, promotions, membership points) that are associated with the loyalty account of the user 102 and that may be applicable to the current transaction. In some embodiments, the benefit verification request message may further include transaction data, such as product information, a transaction date, a transaction location, a transaction amount, items being purchased, etc.

According to various embodiments, the mobile application 112 may be a digital wallet application associated with a digital wallet provider. In such embodiments, the mobile application 112 may communicate with the server computer 130 via the digital wallet provider. However, the mobile application 112 is not limited to a digital wallet application and can be provided by, or otherwise associated with any entity, including but not limited to the server computer 130.

The server computer 130 may use the resource provider identifier to determine the remote processor 140 associated with the resource provider. In some embodiments, the server computer 130 may access a database 180 that maps the resource provider identifier (e.g., a terminal identifier) to a corresponding remote processor 140. As explained above, while the access device 120 and the remote processor 140 may both be associated with the resource provider, the access device 120 may not be capable of direct communication with the remote processor 140. Therefore, the server computer 130 may act as an intermediary to facilitate the communication since the user device 120 may communicate with the server computer 130, which may identify and communicate with the remote processor 140.

In step S4, the server computer 130 may forward the benefit verification request message to the identified remote processor 140. In some embodiments, the server computer 130 may generate a verification request message based on the received benefit verification request message. The verification request message may comply with one or more pre-determined rules of the determined remote processor 140. That is, the server computer 130 may be configured to communicate with the mobile application 112 using a first protocol and with the remote processor 140 using a second protocol. The server computer 130 may transmit the verification request message to the identified remote processor 140.

The remote processor 140 may determine a user's eligibility to apply one or more benefits associated with the loyalty account of the user to the transaction based on a set of factors including one or more of the loyalty account information, the resource provider information, the transaction data, among others. In some embodiments, the determination may further include identifying one or more benefits applicable to the transaction. The remote processor 140 may then generate a verification response message based on the determination of whether or not the benefit account identifier is associated with benefits that can be applied to the transaction. The verification response may include one or more benefits applicable to the transaction.

In step S5, the remote processor 140 may transmit the generated verification response message to the server computer 130.

In step S6, the server computer 130 may transmit the loyalty verification response message back to the mobile application 112 on the mobile device 110. In some embodiments, the server computer 130 may generate a benefit verification request message based on the verification response message received from the remote processor 140. The benefit verification response message may comply with one or more pre-determined rules of the mobile application 112, and include one or more benefits applicable to the transaction. The server computer 130 may transmit the benefit verification response message to the mobile application 112.

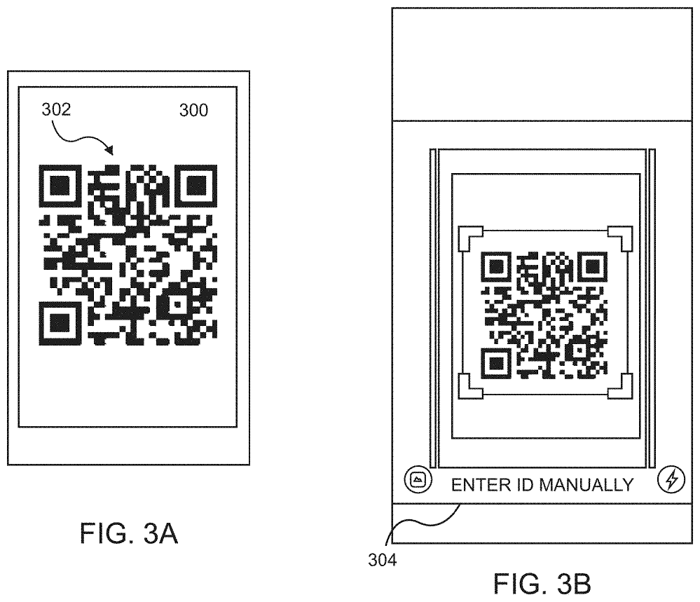

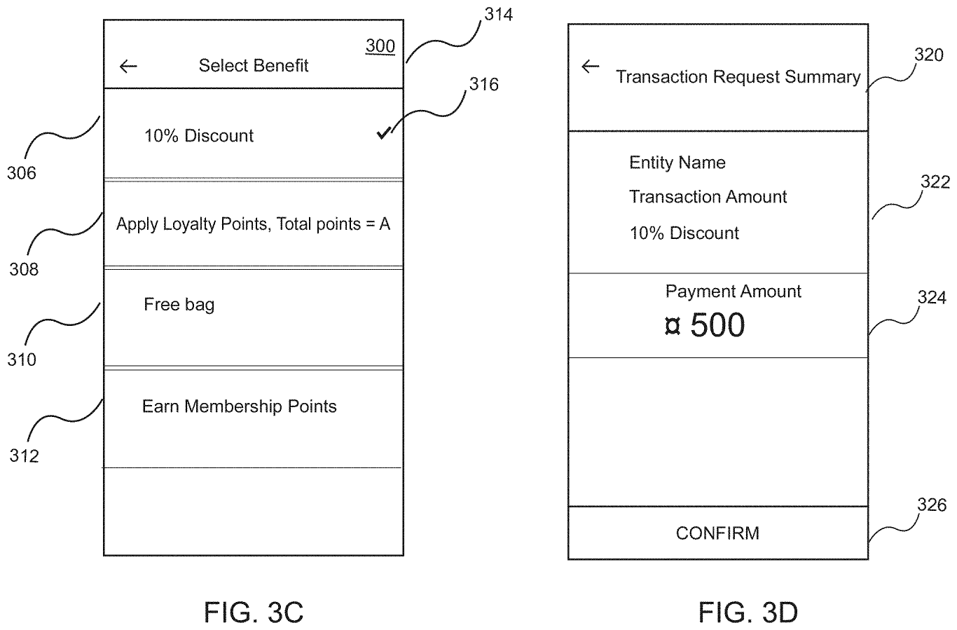

In response to receiving the benefit verification response message, the mobile application 112 may then display on the mobile device 110, applicable benefits such as (but not limited to) a list of loyalty discounts applicable to the transaction, an amount of loyalty points that may be used in the transaction, or free promotional items. These features are discussed below in greater detail in connection with FIGS. 3A-3D.

In some embodiments, the mobile application 112 may further prompt the user 102 to input a transaction amount. In embodiments where a resource provider provides dynamic resource provider identifier (e.g., such as a dynamic QR code) at step 2, the user 102 may additionally be able to receive updated resource provider identifier that includes the transaction amount. For example, if a resource provider presented a dynamic QR code to user 102 in order to initiate a transaction, the user 102 may be able to scan an updated QR code comprising the transaction amount. In other embodiments, where the transaction amount has not change since the user scanned a static QR code using the mobile device 110, the mobile application 112 may already have the transaction amount information.

After a transaction amount has been input or otherwise received, the mobile application 112 may apply the applicable benefits to the transaction in order to determine a final transaction amount. The final transaction amount may be a discounted transaction amount if the selected benefit is a discount. In some embodiments, the final transaction amount may be the same as the initial transaction amount, but the user 102 may receive promotional items (e.g. a bag, a software item, a digital token) for free. The mobile application 112 then presents the final transaction amount to the user 102, wherein the user 102 is prompted to confirm the transaction.

Responsive to the user 102 confirming the transaction, the mobile application 112 may generate a transaction processing request message comprising at least the final transaction amount, the resource provider identifier, a primary account number associated with the user 102 (e.g., or a token corresponding to the primary account number), and/or a cryptogram.

In step S7, the transaction processing request message may be transmitted to the server computer 130. The server computer 130 may then use the resource provider identifier in the transaction processing request message to determine the remote processor 140 associated with the resource provider.

In step S8, the server computer 130 may forward the transaction processing request message to the remote processor 140.

The remote processor 140 may then generate an authorization request message comprising at least the final transaction amount, the primary account number, the token, and/or the cryptogram. In step S9, remote processor 140 may then transmit the generated authorization request message to the determined acquirer computer 150.

In step S10, the acquirer computer 150 may forward the authorization request message to payment processing network 160. The payment processing network 160 may be any suitable network able to transmit and receive financial system transaction messages (e.g., ISO 8583 messages), and process original credit and debit card transactions. An exemplary payment processing system may include VisaNet™. Payment processing systems such as VisaNet™ are able to process credit card transactions, debit card transactions, and other types of commercial transactions.

In step S11, the payment processing network 160 may then forward the authorization request message to issuer computer 170, wherein the issuer computer 170 determines if the user 102 has a sufficient amount of funds to complete the transaction, among other security checks. The issuer computer 170 may generate an authorization response message based on this determination either authorizing or declining the transaction.

In step S12, the issuer computer 170 transmits the generated authorization response message including an indication of the transaction being authorized or declined to the payment processing network 160.

In step S13, the payment processing network 160 forwards the authorization response message to the acquirer computer 150, which then transmits the authorization response message to the remote processor 140 at step S14. In step S15, the remote processor 140 may transmit the authorization response message to the server computer 130.

In step S16, the server computer 130 may forward the authorization response message to the mobile application 112 on mobile device 110. The mobile application 112 may display an indication of the authorization of the transaction to the user 102. If the transaction is authorized, the user 102 may then be granted access to a good or service by the resource provider.

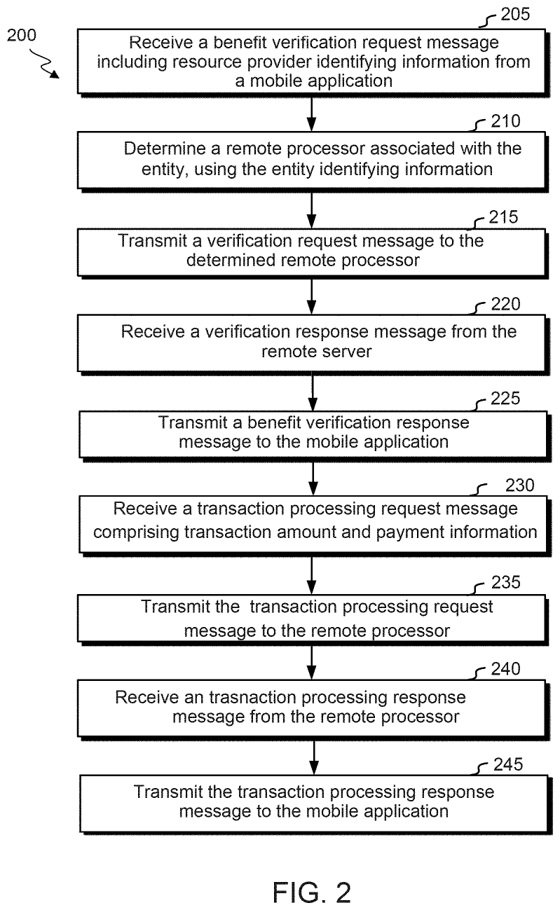

FIG. 2 shows a flowchart diagram for an exemplary method 200 in which a server computer verifies and applies a benefit account identifier during a transaction with a user.

At block 205, the server computer receives a benefit verification request message including at least an entity (e.g. a resource provider, a merchant, an acquirer) identifying information from a mobile application stored on a mobile device. The mobile application may be a mobile payment application and the mobile device may be a smart phone operated by a user. According to various embodiments, the benefit verification request message further includes benefit data such as a benefit account identifier associated with the user of the mobile device. The benefit account identifier may be associated with a benefit account (e.g. a loyalty account, a membership account) of the user. The benefit account may be issued by the entity (e.g. the merchant), the server computer (e.g. a payment processor) or a third party (e.g. a bank, an employer of the user, a government entity).

According to various embodiments, the benefit verification request message is generated by the mobile application in response to the mobile application receiving the entity identifying information in connection with a transaction with the entity.

In some embodiments, the mobile application may receive the entity identifying information in any suitable manner. For example, the mobile application (or another application stored on the mobile device) may receive the entity identifying information from a terminal (e.g. access device) of the entity by scanning a machine-readable code (e.g. a QR code) displayed on the terminal. The machine-readable code may be a static QR code where the information contained therein may not be updated throughout the transaction. In some embodiments, the machine-readable code may be a dynamic QR code where the information contained therein may be updated throughout the transaction. According to other embodiments, the mobile application may receive the entity identifying information from the terminal (e.g. access device) of the entity via near field communications (NFC), Bluetooth™ technology, or any or suitable means. In yet other embodiments, the user of the mobile device may provide the entity identifying information to the mobile application by manually entering the information using virtual or physical keys of the mobile device, or using voice commands.

At block 210, the server computer determines a remote processor associated with the entity using the entity identifying information. For example, the remote processor may be a terminal of the entity on the cloud, such as a virtual merchant terminal on the cloud. In other embodiments, the remote processor may be a transaction processing entity associated with the entity for processing the transactions on behalf of the entity. According to various embodiments, the entity may be incapable of direct communication with the remote processor (e.g. the entity may be offline with respect to the remote processor). For example, the entity may be located at area that does not have network connectivity. In such embodiments, the server computer may act as an intermediary between the access device (via the mobile application on the mobile device) and the remote processor.

At block 215, the server computer transmits a verification request message to the determined remote processor for identifying benefits applicable to the transaction. For example, the verification request message may request the remote processor to identify whether the benefit account identifier is associated with one or more benefits (e.g. discounts, promotions) applicable to the particular transaction between the user of the mobile device and the entity. The one or more benefits may include one or more of a discount, loyalty points, membership points, promotional items associated with the benefit account identifier.

According to various embodiments, the server computer may be configured to communicate with the mobile application using a first protocol (e.g. the communication protocol of the mobile application) and with the remote processor using a second protocol (e.g. the communication protocol of the remote processor). The server computer may be configured to translate messages between the two communication protocols. According to various embodiments, the server computer may transmit the benefit verification request message to the remote processor upon determining that the benefit verification request message received from the mobile application complies with the communication protocol of the remote processor. Alternatively, the server computer may generate the verification request message based on a pre-determined format or rules of the determined remote processor and the benefit verification request message received from the mobile application.

At block 220, the server computer receives a verification response message from the remote processor. The verification response message may include one or more benefits that can be applied to the transaction, the user, and/or the entity. For example, the one or more benefits may include a discount, a promotion, loyalty points, membership points or membership number that may be applied to the transaction. While some of the benefits may result in a modification of the transaction amount (e.g. a discount to be applied to the transaction amount) other benefits may not change the transaction amount (e.g. a promotional item that will be given for free in addition to the full transaction amount, or membership points that can be earned in light of the full transaction amount).

At block 225, the server computer transmits a benefit verification response message to the mobile application stored on the mobile device. The mobile application may display a loyalty result based on the loyalty verification response message to the user. The benefit verification response message may include the one or more benefits received from the remote processor in the verification response message.

According to various embodiments, the server computer may transmit the verification response message to the mobile application upon determining that the verification response message received from the remote processor complies with the communication protocol of the mobile application. Alternatively, the server computer may generate the benefit verification response message based on a pre-determined format or rules of the mobile application and the verification response message received from the remote processor.

Upon receiving the benefit verification response message including the one or more benefits applicable to the transaction, the mobile application may display the one or more benefits as selectable benefits on a display of the mobile device. This feature is discussed below in greater detail in connection with FIGS. 3A-3D.

At block 230, the server computer receives, from the mobile application, a transaction processing request message for the transaction. The transaction processing request message comprises the entity identifying information and a transaction amount based on the benefit verification response message. In addition, the transaction processing request message may include payment credentials (e.g., a primary account number, an expiry date, etc.) associated with the user. The transaction processing request message may also include at least one of the one or more benefits as a selected benefit to be applied to the transaction. In some embodiments, the transaction amount based on the benefit verification response message may include a transaction amount discounted in view of the selected benefit. In other embodiments, the transaction amount may be the full transaction amount (e.g. not discounted, unchanged) in view of the selected benefit being a free promotional item or service, access to an exclusive area or event, or earning additional loyalty points.

At block 235, the server computer transmits the transaction processing request message to the remote processor. The remote processor may initiate an authorization process of the transaction based on information included in the transaction processing request message. For example, the remote processor may generate an authorization request message and conduct an authorization process of the transaction.

At block 240, the server computer receives an authorization response message from the remote processor based on an outcome of the authorization process. The authorization response message may be generated as a result of the authorization process. The authorization response message may indicate whether the transaction has been approved or declined. If the transaction is approved, and the selected benefit is a discount applied to the transaction amount, the user account will only be charged the discounted transaction amount.

At block 245, the server computer transmits a transaction processing response message to the mobile application stored on the mobile device. The transaction processing response message may include the authorization response message or may be generated based on the authorization response message. The mobile application may then display an authorization result to the user of the mobile device.

FIGS. 3A-3D show a series of exemplary screen views of a mobile device for receiving and selecting benefits applicable to a transaction according to various embodiments. As explained above, the benefits applicable to a transaction or at a resource providing entity may be identified by the server computer using a resource providing entity identifier (e.g. entity identifying information). According to various embodiments, the resource providing entity identifier may be the only information required to identify the benefits. In other embodiments, the server computer may also receive a user loyalty account identifier from the mobile application.

In some embodiments, the mobile application 300 installed on the mobile device of the user may receive the resource providing entity identifier. As illustrated in FIG. 3A, the mobile application 300 may scan a machine-readable code 302 (for example, using a camera of the mobile device) for receiving the resource providing entity identifier. The machine-readable code 302 may be a static code which may not be modified upon scanning. In some embodiments, the machine-readable code 302 may be a dynamic code, wherein information associated with the dynamic machine-readable code may be updated throughout the transaction.

The mobile application 300 may receive the resource providing entity identifier in any suitable manner, and is not limited to scanning a machine-readable code as illustrated in FIG. 3A. For example, when the machine-readable code cannot be scanned, or when there is no machine-readable code, the user may enter the resource providing entity identifier manually by selecting a widget option 304 displayed on the mobile application 300, as shown in FIG. 3B. According to other embodiments, the mobile application 300 may receive the resource providing entity identifier through the microphone of the mobile device (e.g. the user may speak the resource providing entity identifier).

The mobile application 300 may then transmit the resource providing entity identifier to the server computer, and may thereafter receive one or more benefits applicable to the transaction (and/or the resource provider associated with the resource providing entity identifier). FIG. 3C illustrates a plurality of exemplary applicable benefits: a discount benefit 306, an option to apply loyalty points to the transaction along with an indication of total available points 308, a promotional item such as a free bag 310, and an option to earn additional membership points 312. The mobile application 300 may ask the user to select one of the displayed benefits. The instructions to select the benefit 314 may be displayed as part of the user interface associated with the application 300. The user may select one or more of the displayed benefits. For example, in the exemplary embodiment illustrated in FIG. 3C, the user may select the discount option 306. The selection may be visually illustrated (e.g. using a visual cue, color schemes, symbols, etc.) on the mobile application 300. For example a visual cue 316 may be shown in connection with the selected benefit.

Upon receiving the user's selection of one or more benefits, the mobile application 300 may generate a transaction processing request message. The mobile application may also display a transaction request summary 320 for user approval, as shown in FIG. 3D. For example, the mobile application 300 may display transaction information 322 including the resource providing entity's name, the transaction amount, and the selected benefit (e.g. the discount in the illustrative example). The transaction request summary 320 may also include the payment amount 324 (e.g. the final transaction amount, including any applicable discounts). The mobile application may ask the user to confirm the transaction request by, for example, selecting a widget 326 displayed on the mobile application.

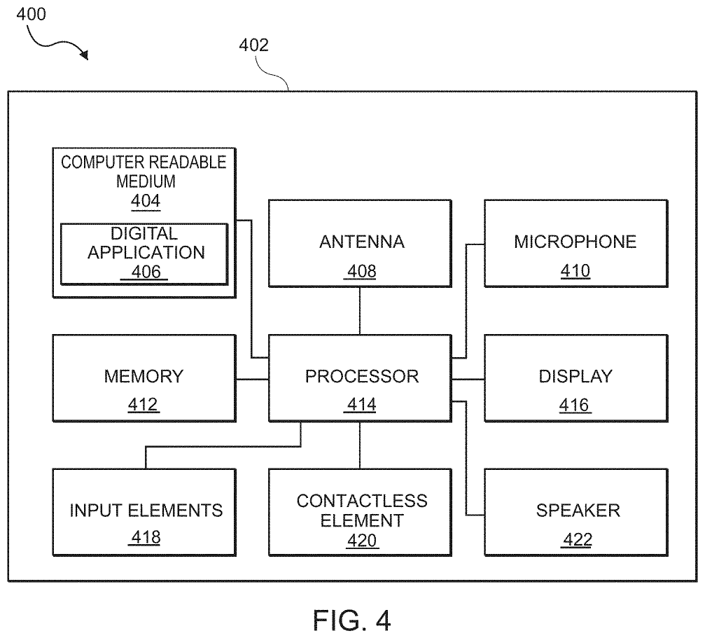

As described above, the mobile application is stored, or installed on a mobile device. FIG. 4 shows a block diagram of a mobile device 400 according to various embodiments. In some embodiments, the mobile device 400 may be a payment device that can be used to make payments or a device which can allow a user to gain access to a location or secure data. The exemplary mobile device 400 may comprise a computer readable medium 404 that can be present within the body 402 of the mobile device 400. The computer readable medium 404 may be in the form of a memory that stores data. In some cases, the memory 412 may also store information such as access data including access data reference identifiers and communication device identifiers. In general, any of this information may be transmitted by the mobile device 400 to another device, using any suitable method, including the use of antenna 408 or contactless element 420. The body 402 may be in the form a plastic substrate, housing, or other structure.

The computer readable medium 404 may comprise a digital application (e.g. the mobile application) 406. The digital application 406 may be a digital wallet application, a secure data access application, a secure location access application, etc. The computer readable medium 404 may comprise code, executable by the processor for implementing a method comprising receiving entity identifying information for an entity; generating a benefit verification request message comprising benefit data and entity identifying information for an entity; transmitting the benefit verification request message to a server computer; receiving benefit verification request message comprising benefit data and entity identifying information for an entity; displaying one or more benefits included in the benefit verification request message on a display of the mobile device, receiving a selection of one or more benefits; generating a transaction processing request message for the transaction, wherein the transaction processing request message comprises the entity identifying information and a transaction amount based on the selected one or more benefits; transmitting the transaction processing request message to the server computer; and receiving, from the server computer, an authorization response message indicating whether the transaction is approved or declined.

In some embodiments, the mobile device 400 may further include a contactless element 420, which is typically implemented in the form of a semiconductor chip (or other data storage element) with an associated wireless transfer (e.g., data transmission) element, such as an antenna. Contactless element 420 may be coupled to (e.g., embedded within) the mobile device 400 and data or control instructions that are transmitted via a cellular network may be applied to the contactless element 420 by means of a contactless element interface (not shown). Contactless element 420 may be capable of transferring and receiving data using a short range wireless communication capability. The mobile device 400 may comprise components to both receive and send data. Thus, the mobile device 400 may be capable of communicating and transferring data or control instructions via both cellular network (or any other suitable wireless network—e.g. the Internet or other data network) and short range communications.

The mobile device 400 may also include a processor 414 (e.g., a microprocessor) for processing the functions of the mobile device 400 and a display 416 to allow a consumer to see phone numbers and other information and messages. The mobile device 400 may further include input elements 418 to allow a user to input information into the device, a speaker 422 to allow the user to hear voice communication, music, etc., a microphone 410 to allow the user to transmit their voice through the mobile device 400, and a camera to take pictures or scan machine-readable codes. The mobile device 400 may also include an antenna 408 for wireless data transfer (e.g., data transmission).

The memory 412 may be in the form of one or more memory devices (e.g., RAM, EEPROM, ROM chips), using any suitable mode of data storage. In some embodiments, the memory 412 in the mobile device 400 may also include a secure storage area for storing sensitive data such as payment credentials (account numbers, payment tokens, verification values, etc.) and access data. For example, the memory 412 may be part of or may contain a secure element.

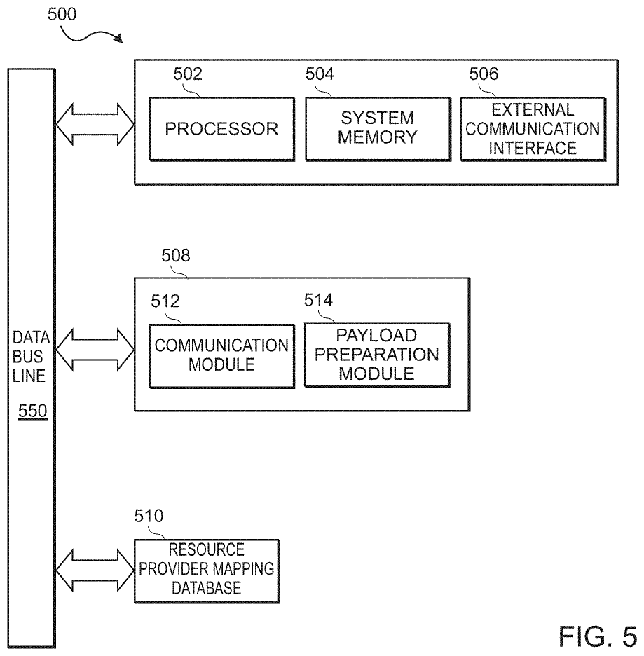

FIG. 5 shows a block diagram of components of a server computer 500 in an SRT system. The server computer 500 may comprise a processor 502, which may be coupled to a system memory 504 and an external communication interface 506. A computer readable medium 508 may also be operatively coupled to the processor 502. The components may communicate with each other via a data bus line 550. The computer readable medium 508 may comprise code, executable by the processor 502, to perform a method including receiving a benefit verification request message comprising benefit data and entity identifying information for an entity from a mobile application on a mobile device; determining a remote processor associated with the entity using the entity identifying information; transmitting a verification request message to the determined remote processor for verifying the benefit data in view of the transaction; receiving a verification response message from the remote processor; transmitting a benefit verification response message to the mobile application on the mobile device; receiving, from the mobile application, a transaction processing request message for the transaction; and transmitting the transaction processing request message to the remote processor.

The computer readable medium 508 may also comprise a number of software modules including a communication module 512, and a payload preparation module 514.

The communication module 512 may comprise code that causes the processor 502 to generate messages, forward messages, reformat messages, and/or otherwise communicate with other entities.

The payload preparation module 514 may comprise code that can cause the processor 502 to search one or more databases and retrieve data from those databases to prepare a payload that is to be sent to another entity (e.g. the remote processor).

The resource provider mapping database 510 may store data that maps resource provider identifiers to certain entities (e.g., remote processors) that process transactions on behalf of the resource provider entities. The remote processors may include a terminal of the resource provider entity on the cloud or a payment processor associated with the resource provider entity.

Embodiments have a number of advantages. In embodiments, a server computer may act as an intermediary between a resource provider and/or a user, and a remote processor associated with the resource provider. The server computer may work with the remote processor to identify and transmit applicable benefits (e.g. discounts, loyalty benefits, promotions, membership numbers) to a mobile device of the user for application to a transaction with the resource provider. The server computer acts as a third-party between the user and the merchant, which provides a means of applying loyalty information without changing an existing payment infrastructure. The server computer may identify the remote processor associated with the resource provider based on an identifier associated with the resource provider, which the server computer receives from the mobile application on the user's mobile device. Embodiments enable application of benefits to a transaction even when the resource provider is offline (e.g. not in direct communication) with respect to the remote processor as well as the server computer. The server computer facilitates the communication with the remote processor on behalf of the user and/or the resource provider.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations may become apparent to those skilled in the art upon review of the disclosure. The scope of the embodiments can, therefore, be determined not with reference to the above description, but instead can be determined with reference to the pending claims along with their full scope or equivalents.

One or more features from any embodiment may be combined with one or more features of any other embodiment without departing from the scope of the present disclosure.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer, a benefit verification request message comprising benefit data and entity identifying information for an entity from a mobile application on a mobile device, wherein the benefit verification request message is generated by the mobile application in response to the mobile application receiving the entity identifying information in connection with a transaction with the entity;
determining, by the server computer, a remote processor associated with the entity using the entity identifying information;
transmitting, by the server computer, a verification request message to the determined remote processor for verifying the benefit data in view of the transaction;
receiving, by the server computer, a verification response message from the remote processor;
transmitting, by the server computer, a benefit verification response message to the mobile application on the mobile device, wherein the benefit verification response message includes one or more benefits applicable to the transaction;
receiving, by the server computer from the mobile application, a transaction processing request message for the transaction, wherein the transaction processing request message comprises the entity identifying information and a transaction amount based on the benefit verification response message; and
transmitting, by the server computer, the transaction processing request message to the remote processor, wherein the remote processor initiates an authorization process of the transaction based on information included in the transaction processing request message.

2. The method of claim 1, wherein the transaction processing request message includes at least one of the one or more benefits as a selected benefit to be applied to the transaction.

3. The method of claim 2, wherein the transaction amount based on the benefit verification response message includes the transaction amount discounted in view of the selected benefit.

4. The method of claim 1, wherein the one or more benefits include one or more of a discount, loyalty points, or membership points.

5. The method of claim 1, wherein the entity identifying information is in a QR code which is scanned by the mobile device, the QR code being a static QR code or a dynamic QR code.

6. The method of claim 1, wherein the benefit verification request message further comprises a benefit account identifier associated with a user of the mobile device.

7. The method of claim 1, wherein the entity identifying information is entered to the mobile device by a user of the mobile device.

8. The method of claim 1, wherein the entity is incapable of direct communication with the remote processor.

9. The method of claim 1, wherein transmitting, by the server computer, a verification request message to the determined remote processor for verifying benefits applicable to the transaction comprises:
generating the verification request message based on one or more pre-determined rules of the determined remote processor, wherein the server computer is configured to communicate with the mobile application using a first protocol and with the remote processor using a second protocol.

10. The method of claim 1, wherein transmitting, by the server computer, a benefit verification response message to the mobile application on the mobile device comprises:
generating the benefit verification response message based on one or more pre-determined rules of the mobile application, wherein the server computer is configured to communicate with the mobile application using a first protocol and with the remote processor using a second protocol.

11. A server computer comprising:
a processor; and
a computer readable medium, the computer readable medium comprising code, when executed by the processor, causes the processor to:
receive a benefit verification request message comprising benefit data and entity identifying information for an entity from a mobile application on a mobile device, wherein the benefit verification request message is generated by the mobile application in response to the mobile application receiving the entity identifying information in connection with a transaction with the entity;
determine a remote processor associated with the entity using the entity identifying information;
transmit a verification request message to the determined remote processor for verifying the benefit data in view of the transaction;
receive a verification response message from the remote processor;
transmit a benefit verification response message to the mobile application on the mobile device, wherein the benefit verification response message includes one or more benefits applicable to the transaction;
receive, from the mobile application, a transaction processing request message for the transaction, wherein the transaction processing request message comprises the entity identifying information and a transaction amount based on the benefit verification response message; and
transmit the transaction processing request message to the remote processor, wherein the remote processor initiates an authorization process of the transaction based on information included in the transaction processing request message.

12. The server computer of claim 11, wherein the code, when executed by the processor, causes the processor to:
receive a transaction processing response message from the remote processor based on an outcome of the authorization process; and
transmit the transaction processing response message to the mobile application.

13. The server computer of claim 11, wherein the transaction processing request message includes at least one of the one or more benefits as a selected benefit to be applied to the transaction, and wherein the transaction amount based on the benefit verification response message includes the transaction amount discounted in view of the selected benefit.

14. The server computer of claim 11, wherein the benefit data includes a benefit account identifier associated with a user of the mobile device, and the one or more benefits include one or more of a discount, loyalty points, or membership points associated with the benefit account identifier.

15. The server computer of claim 14, wherein the benefit account identifier is issued by the entity, the server computer or a third party.

16. The server computer of claim 11, wherein the entity identifying information is in a QR code which is scanned by the mobile device.

17. The server computer of claim 11, wherein the entity identifying information is received by the mobile device.

18. The server computer of claim 11, wherein the transaction processing request message includes at least one of the one or more benefits as a selected benefit to be applied to the transaction, and wherein the transaction amount remains unchanged in view of the selected benefit.

19. The server computer of claim 11, wherein the server computer is configured to communicate with the mobile application using a first protocol and with the remote processor using a second protocol, and wherein the code, when executed by the processor, causes the processor to:
generate the verification request message based on a pre-determined format of the determined remote processor, and
generate the benefit verification response message based on a pre-determined format of the mobile application.

20. The server computer of claim 11, wherein the benefit verification response message displays one or more selectable benefits on the mobile device.
